(19) United States
(12) Patent Application Publication
(10) Pub. No.: US 2025/0034833 A1
(43) Pub. Date: Jan. 30, 2025

(54) QUICK COUPLING SYSTEM

(71) Applicant: OilQuick Deutschland KG, Steindorf (DE)

(72) Inventor: Stefan SCHAUER, Kissing (DE)

(73) Assignee: OilQuick Deutschland KG, Steindorf (DE)

(21) Appl. No.: 18/779,514

(22) Filed: Jul. 22, 2024

(30) Foreign Application Priority Data
Jul. 27, 2023 (DE) 10 2023 119 932.3

(51) Int. Cl. E02F 3/413; B66C 1/42; B66C 1/44; E02F 3/96

(52) U.S. Cl. CPC E02F 3/4135; B66C 1/427; B66C 1/44; E02F 3/963

(57) ABSTRACT

A quick coupling system for changing attachments on a construction machine, which contains a quick coupler arranged on a support so as to be rotatable about a rotary axis by means of a rotary drive and/or pivotable about a swivelling axis by means of a swivel drive for coupling a tool or an attachment part. A gripping tong arrangement, which can be actuated by means of a gripper drive, is arranged on the quick coupler and has a plurality of gripper arms which can be moved against each another, and exchangeable gripper elements are arranged on the gripper arms.

### FIELD OF THE INVENTION

The invention relates to a quick coupling system for changing attachments on a construction.

### BACKGROUND

Such quick coupling systems are used on excavators or other comparable construction machines between an attachment part of the construction machine and the tool as a rotary-swivel unit to extend the movement options. Such quick coupling systems usually contain a quick coupler arranged on a connecting part so that it can rotate about a rotary axis by means of a hydraulic rotary drive and swivel about a swivelling axis orthogonal to the rotary axis by means of a hydraulic swivel drive, which has receptacles and at least one locking element for releasably holding an attachment coupled to the quick coupler. By means of such a quick coupling system, the attachments coupled to the quick coupler, such as swivel buckets, grippers, shears, compactors, magnets, hydraulic hammers or the like, can be rotated not only about a swivelling axis arranged transversely to the longitudinal axis of an excavator stick, but also about a rotary axis orthogonal to this swivelling axis. Such a quick coupling system is known from DE 10 2020 127 313 B3.

### SUMMARY OF THE INVENTION

One aspect of the invention relates to a quick coupling system which enables an extended range of applications.

Accordingly, a quick coupling system is disclosed herein. Useful embodiments and advantageous further embodiments of the invention are also disclosed herein.

The quick coupling system according to the invention for changing attachments on a construction machine contains a quick coupler for coupling a tool or attachment part, which is arranged on a support so as to be rotatable about a rotary axis by means of a rotary drive and/or pivotable about a swivelling axis by means of a swivel drive. To extend the range of applications, a gripping tong arrangement with several gripper arms that can be moved against each other is arranged on the quick coupler, which can be actuated by means of a gripping tong drive and can be easily retrofitted if required. This allows, for example, pipes, rings, bars, stones or the like to be gripped and transported. In order to adapt the gripping tong arrangement relatively easily and cost-effectively to the different requirements, exchangeable gripper elements are arranged on the gripper arms. This makes it easy to extend the range of applications. The entire gripping tong arrangement does not have to be rebuilt and changed to adapt to the different requirements and areas of application. Only the gripper elements arranged separately on the gripper arms need to be replaced.

In a preferred embodiment, the quick coupler with the gripping tong arrangement arranged on it is arranged on the support so as to be rotatable about the rotary axis by means of the rotary drive and pivotable about the swivelling axis orthogonal to the rotary axis by means of the swivel drive. This allows the gripping tong arrangement not only to be rotated, but also tilted. However, the quick coupler can also be arranged on the support so that it can only be rotated or tilted.

The gripping tong arrangement preferably has two gripper arms arranged on a support structure so that they can pivot in relation to each other. However, the gripping tong arrangement can also contain more than two gripper arms.

In a preferred embodiment, the gripper elements, which are individually adapted to the desired area of application, can be attached to the gripper arms via a non-destructive detachable connection. This allows the gripper elements to be exchanged or replaced particularly quickly and without major conversion effort. However, the gripper elements can also be welded to the gripper arms or fixed to the gripper arms in another suitable way. Even then, the gripper elements can be replaced with somewhat greater effort. It is not necessary to replace the entire gripper arm to adapt it to a specific area of application.

In one practical embodiment, the gripper elements have an outer clamping surface for gripping components on the inside. The gripper elements can also have an outwardly projecting projection with a stop surface. In a further advantageous embodiment, elastic pressing bodies can be arranged on the gripper elements. This allows sensitive components made of marble or the like to be gripped, for example.

In an advantageous embodiment, the gripping tong drive can contain a first gripper cylinder for driving a first gripper arm and a second gripper cylinder for driving a second gripper arm. However, the gripping tong drive can also be designed differently.

The support preferably has two side plates parallel to each other with openings to accommodate two parallel bolt-shaped connecting elements. This allows the support to be arranged directly on an excavator arm or coupled to a quick coupler arranged on the excavator arm via the bolt-shaped connecting elements.

### BRIEF DESCRIPTION OF THE DRAWINGS

Further special features and advantages of the invention are shown in the following description of preferred embodiments with reference to the drawing. It shows:

FIG. 1 perspective view of a quick coupling system with a gripping tong arrangement;

FIG. 2 a gripping tong arrangement in a perspective view;

FIG. 3 an exploded view of a gripping tong arrangement;

FIG. 4 a detailed view of a gripper arm of the gripping tong arrangement shown in FIG. 2 and

FIG. 5 a detailed view of a gripper arm in a further design.

### DETAILED DESCRIPTION

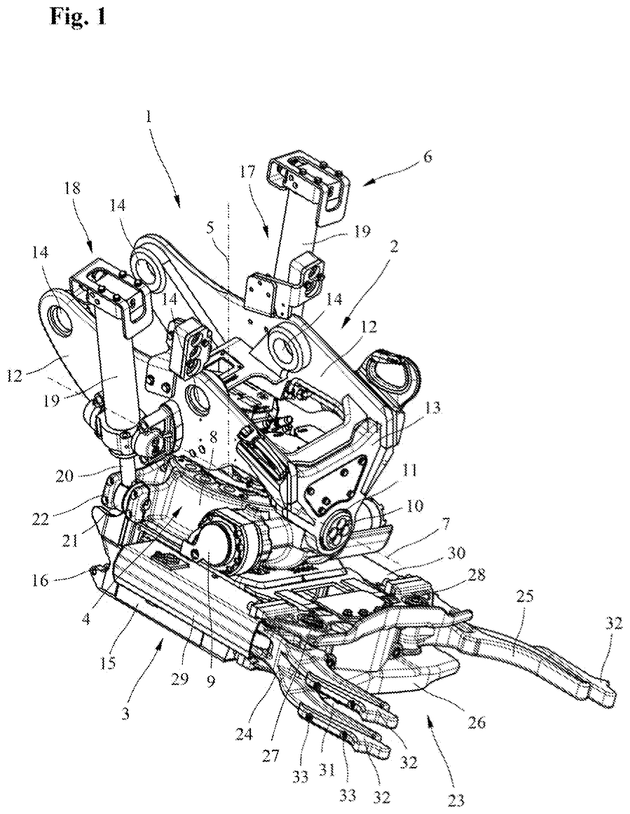

FIG. 1 shows a quick coupling system 1, also known as a tiltrotator, for changing attachments on an excavator or comparable construction machine. The quick coupling system 1 contains a quick coupler 3, which is arranged on a support 2 so that it can rotate and swivel by means of a rotary and swivel drive and is designed for the automatic or manual coupling of attachments. In the embodiment shown, the quick coupler 3 is arranged on the support 2, which can be coupled either directly or via a hydraulically actuated quick coupler to an excavator stick or another attachment element of a construction machine, so that it can be rotated through 360° about a rotary axis 5 by means of a hydraulic rotary drive 4 and swiveled about a swivelling axis 7 orthogonal to the rotary axis 5 by means of a hydraulic swivel drive 6.

The quick coupling system 1, designed here as a tilt rotator, contains a drive housing 8 in which the quick coupler 3 is mounted so that it can rotate through 360° about the rotary axis 5, which is aligned vertically here. In the drive housing 8 there is also a hydraulic rotary feedthrough, not visible here, with a stator arranged in the drive housing 8 so as to be non-rotatable relative to it and a rotor rotatably mounted inside the stator for supplying a hydraulic fluid to the quick coupler 3. The rotary drive 4 contains a hydro motor 9 designed as a hydraulic drive, by means of which the quick coupler 3 can be rotated 360° relative to the drive housing 8 about the rotary axis 5 via a gearbox with a worm wheel arranged inside the drive housing 8 and a drive worm rotatable by the hydro motor 9.

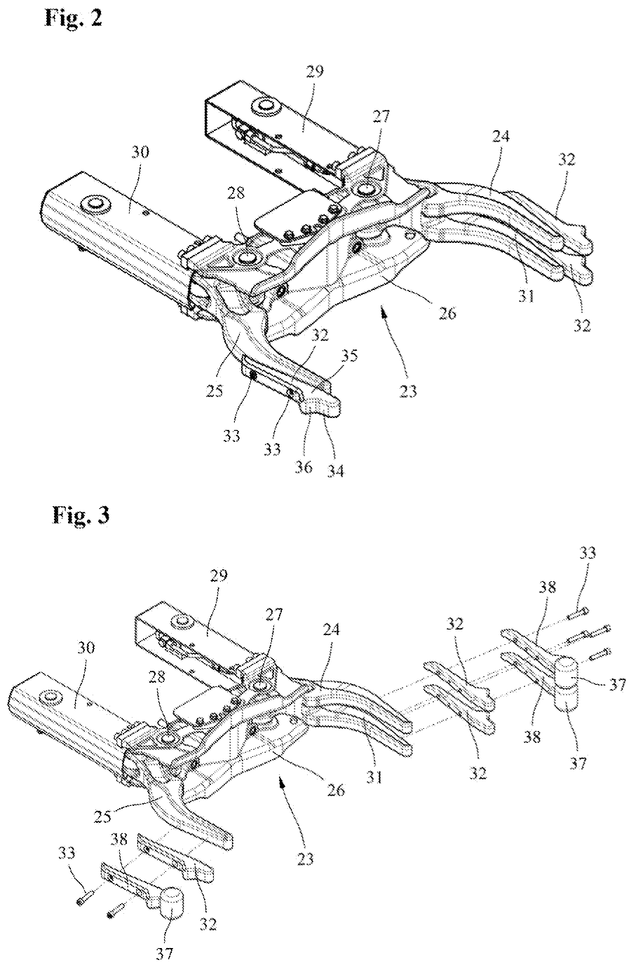

The drive housing 8 is arranged on the support 2 via laterally projecting bearing pins 10 within two spaced-apart bearing eyes 11 so that it can swivel about the swivelling axis 7, which is orthogonal to the rotary axis 5, and can be swivelled via the hydraulic swivel drive 6 relative to the connecting part 1 about the swivelling axis 6 by approx. +/−45° compared to the position shown in FIGS. 1 and 2. The excavator attachment 1, designed here as a tilt rotator, allows the attachments coupled to the quick coupler 3 not only to be rotated about the rotary axis 5, but also to be tilted relative to the support 2 about the swivelling axis 7, which is orthogonal to the rotary axis 5, thus extending the range of movement and thereby increasing the area of application. However, the quick coupling system 1 can also be designed to only rotate or swivel the quick coupler 3.

In the embodiment example shown, the support 2 has two side plates 12 parallel to each other as well as front and rear cross pieces 13 with bearing eyes 11 arranged on them. The drive housing 8 is pivotably mounted about the swivelling axis 7 via the two bearing pins 10 in the bearing eyes 11 of the front and rear cross pieces 13. In the two side plates 12 of the connection part 1 shown, four openings 14 are provided to accommodate two parallel bolt-shaped connecting elements.

The manually or hydraulically actuable quick coupler 3, which is designed for coupling an attachment or tool, contains a housing 15, which has first receptacles 16 open to one side for receiving and holding a tool-side first bolt-shaped coupling element on one side and second receptacles—not visible here—on the other side for receiving and holding a tool-side second bolt-shaped coupling element. An example embodiment of a hydraulically actuated quick coupler 3 for automatically coupling a tool is disclosed in DE 10 2018 128 479 A1. Reference is expressly made to this publication with regard to the known structure and mode of operation of such a hydraulically actuated quick coupler. However, the quick coupler 3 can also be designed as a manually operated quick coupler. An embodiment example of a manually operated quick coupler is disclosed, for example, in DE 20 2017 001 992 U1.

In the embodiment shown, the swivel drive 6 is formed by two double-acting actuating cylinders 17 and 18, each with a cylinder housing 19 attached to the respective side plate 12 of the support 2 and a hydraulically movable piston rod 20 slidably arranged in the cylinder housing 19. The free ends of the piston rods 20 are connected to the drive housing 8 via a hinge eye 21 and a corresponding holder 22. By correspondingly extending and retracting the two piston rods 20 of the actuating cylinders 17 and 18, the drive housing 8 with the quick coupler 3 rotatably mounted therein can be tilted relative to the connecting part 2. However, the swivel drive 6 can also be formed by a hydro motor or another suitable hydro drive.

A gripping tong arrangement 23 with two gripper arms 24 and 25 that can be swivelled against each other is also arranged on the support 15 of the quick coupler 3 which can be easily retrofitted and removed again if required. The two gripper arms 24 and 25 are arranged on a support structure 26, also shown in FIG. 2, so that they can each pivot about an axis 27 or 28 and can be folded out or in via a hydraulic gripper tong drive formed here by two double-acting gripper cylinders 29 or 30. One of the two gripper arms 24 and 25 has a slot-shaped recess 31 to accommodate the other gripper arm 5. This allows the two gripper arms 24 and 25, each of which can be pivoted by a gripper cylinder 29 or 30, to be moved into each other when folded in and folded in completely. In contrast to FIG. 1, in which the gripper arm 24 provided with the slot-shaped recess 31 is arranged on the left side of the support structure 26, the gripper arm 24 provided with the slot-shaped recess 31 is arranged on the right side of the support structure 26 in the embodiment of FIG. 2. The support structure 26 is symmetrical, so that it can be easily mounted on the quick coupler 3 in two different positions, i.e. rotated by 180°.

As can be seen from FIGS. 1 and 2, separate interchangeable gripper elements 32 are arranged on the two gripper arms 24 and 25. In the embodiment example shown, the gripper elements 32 are attached to the gripper arms 24 and 25 via screws 33 or another non-destructively detachable connection. While two gripper elements 32 are attached to the gripper arm 24 provided with the slot-shaped recess 31, one above and one below the recess 31, only one gripper element 32 is attached to the other gripper arm 25.

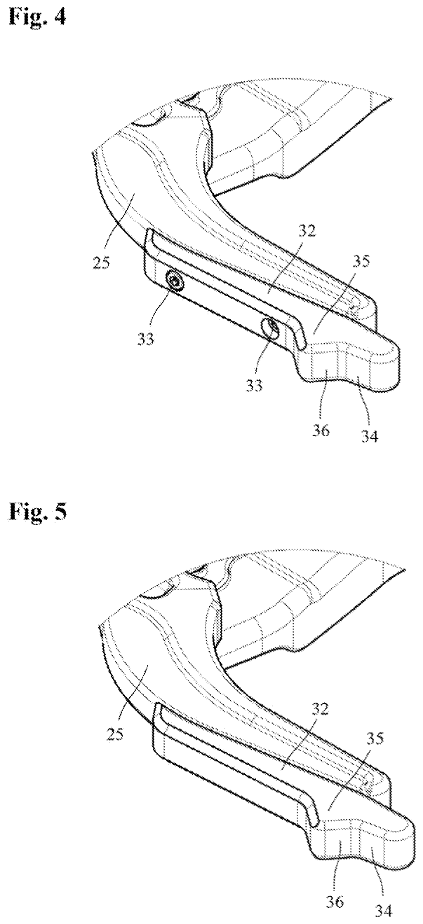

The gripper elements 32 shown in FIGS. 1 and 2 are designed, for example, for gripping the inside of manhole rings, pipes or the like. As can be seen in particular from the enlarged representation of FIGS. 4 and 5, these gripper elements 32 have a straight outer clamping surface 34 and an outwardly projecting nose-shaped projection 35 with a stop surface 36. By moving the two gripper arms 24 and 25 apart, the mutually parallel clamping surfaces 34 of the two gripper elements 32 can be used, for example, to clamp manhole pipes or other parts from the inside and hold them for transportation. In the embodiment shown in FIG. 4, the gripper elements 32 are detachably attached to the gripper arms via screws 33 and can therefore be easily exchanged or replaced. However, the gripper elements 32 can also be welded to the gripper arms or fixed to the gripper arms in another suitable manner, as shown in FIG. 5. The gripper elements 32 can then also be replaced or changed to adapt to a different requirement. However, the change is then associated with greater effort.

Instead of the gripper elements 32 shown in FIGS. 1 and 2, other gripper elements adapted to a special area of application can of course also be attached to the gripper arms 24 and 25. In FIG. 3, for example, gripper elements 38 provided with rubber buffers or other elastic pressing bodies 37 are mounted on the gripper arms 24 and 25. This allows sensitive components made of marble or the like to be gripped, for example. Other specially adapted gripper elements can also be mounted easily and quickly.

### List of reference symbols

1 excavator attachment

2 support

3 quick coupler

4 rotary drive

5 rotary axis

6 swivel drive

7 swivelling axis

8 drive housing

9 hydro motor

10 bearing pin

11 bearing eyes

12 side plate

13 cross piece

14 opening

15 housing

16 receptacle

17 first actuating cylinder

18 second actuating cylinder

19 cylinder housing

20 piston rod

21 hinge eye

22 holder

23 gripping tong arrangement

24 first gripper arm

25 second gripper arm

26 support structure

27 first axis

28 second axis

29 first gripper cylinder

30 second gripper cylinder

31 recess

32 gripper element

33 screw

34 clamping surface

35 projection

36 stop surface

37 pressing body

38 gripper element

1. A quick coupling system for changing attachments on a construction machine, the system comprising:
a quick coupler arranged on a support so as to be rotatable about a rotary axis by means of a rotary drive and/or pivotable about a swivelling axis by means of a swivel drive for coupling a tool or an attachment part,
wherein a gripping tong arrangement, which can be actuated by means of a gripping tong drive, with a plurality of gripper arms which can be moved against each other another is arranged on the quick coupler, and
wherein exchangeable gripper elements are arranged on the gripper arms.

2. The quick coupling system according to claim 1, wherein the quick coupler with the gripping tong arrangement arranged thereon is arranged on the support so as to be rotatable about the rotary axis by means of the rotary drive and pivotable about the swivelling axis orthogonal to the rotary axis by means of the swivel drive.

3. The quick coupling system according to claim 1, wherein the gripping tong arrangement contains two gripper arms arranged on a support structure so as to be pivotable against each another.

4. The quick coupling system according to claim 1, wherein the gripper elements are removably attached to the gripper arms via a non-destructively detachable connection.

5. The quick coupling system according to claim 1, wherein the gripper elements are welded to the gripper arms.

6. The quick coupling system according to claim 1, wherein the gripper elements contain an outer clamping surface for internal gripping of components.

7. The quick coupling system according to claim 1, wherein the gripper elements contain an outwardly projecting projection with a stop surface.

8. The quick coupling system according to claim 1, wherein elastic pressing bodies are arranged on the gripper elements.

9. The quick coupling system according to claim 1, wherein the gripping tong drive contains a first gripper cylinder for driving a first gripper arm and a second gripper cylinder for driving a second gripper arm.

10. The quick coupling system according to claim 1, wherein the support contains two side plates parallel to each other with openings to accommodate two parallel bolt-shaped connecting elements.
